(19) United States
(12) Patent Application Publication
(10) Pub. No.: US 2004/0190988 A1
(43) Pub. Date: Sep. 30, 2004

(54) Coupling device for beams or bars of furniture

(76) Inventor: Keng Nong Chen, Tainan (TW)

Correspondence Address: CHARLES E. BAXLEY, ESQUIRE, Fifth Floor, 59 John Street, New York, NY, 10038, US

(21) Appl. No.: 10/397,897

(22) Filed: Mar. 26, 2003

(51) Int. Cl. F16B 2/18

(52) U.S. Cl. 403/374.4

(57) ABSTRACT

A coupling device includes one or more coupler members each having a strut member engaged into a beam, a catch received in a chamber of the coupler member and having an inclined outer structure inclined from one side toward the other side, for allowing the one side of the catch to be easily engaged into the chamber of the coupler member. A fastener may be engaged through the coupler member, and threaded with the catch, in order to move the catch relative to the strut member, and to selectively force the strut member to engage with and to lock the beam.

### BACKGROUND OF THE INVENTION

1. Field of the Invention

The present invention relates to a coupling device, and more particularly to a coupling device for coupling beams or bars and coupler members of furniture facilities together.

2. Description of the Prior Art

Typical furniture facilities comprise a number of beams or bars that are required to be secured together with fasteners, latches, catches, adhesive materials, or by welding processes. Normally, the typical furniture facilities comprise a number of couplers or ends or corners to be secured between the beams or bars, and a number of fasteners engaged through the couplers or ends or corners and the beams or bars of the furniture facilities, in order to secure the couplers or ends or corners and the beams or bars of the furniture facilities together.

For example, U.S. Pat. No. 5,996,828 to Cheyn discloses one of the typical corner assembly for boxes or furniture facilities, and comprises a number of couplers or ends or corners to be secured between the beams or bars or panels. The couplers or ends or corners comprise two or more legs or extensions extended therefrom for engaging into the beams or bars of the furniture facilities, and the secured to the beams or bars of the furniture facilities with latches or catches.

However, the couplers or ends or corner assemblies of the boxes or furniture facilities may not be made to snugly engage into the respective beams or bars of the furniture facilities, such that the beams or bars of the furniture facilities may be easily become loose relative to the couplers or ends or corners of the boxes or furniture facilities.

The present invention has arisen to mitigate and/or obviate the afore-described disadvantages of the conventional coupling devices for beams or bars of furniture facilities.

### SUMMARY OF THE INVENTION

The primary objective of the present invention is to provide a coupling device for easily and solidly coupling beams or bars and coupler members of furniture facilities together.

In accordance with one aspect of the invention, there is provided a coupling device comprising a beam, at least one coupler member including a strut member engaged into the beam, and having a chamber formed therein, a catch received in the chamber of the coupler member, and including a first side and a second side, and including an inclined outer configuration inclined from the first side toward the second side thereof, and the first side of the catch being provided for easily engaging into the chamber of the coupler member, and means for moving the catch relative to the strut member, to selectively force the strut member to engage with the beam, and to lock the strut member to the beam.

The strut member of the coupler member includes at least one slot formed therein, to form one or more spring blades in the strut member, and for allowing the spring blades to be resiliently and easily forced to engage with the beam by the catch.

The coupler member includes an orifice formed therein, the catch includes a screw hole formed therein, the moving means includes a fastener engaged through the orifice of the coupler member, and threaded with the screw hole of the catch, in order to move the catch relative to the strut member when the fastener is rotated relative to the coupler member and the catch.

The coupler member includes a cavity formed therein and communicating with the orifice thereof, the fastener includes a head engaged in the cavity of the coupler member. A cap may further be provided and engaged onto the coupler member, in order to block the cavity of the coupler member, and to shield the head of the fastener.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of a furniture facility including a coupling device in accordance with the present invention;

FIG. 2 is a partial exploded view of the coupling device;

FIG. 3 is another partial exploded view of the coupling device;

FIG. 4 is a front plan view of a catch of the coupling device;

FIG. 5 is a left side view of the catch of the coupling device;

FIG. 6 is a right side view of the catch of the coupling device;

FIG. 7 is a left side view of the coupling device as shown in FIG. 8;

FIG. 8 is a cross sectional view taken along lines 8-8 of FIG. 7;

FIG. 9 is a left side view similar to FIG. 7, showing the coupling device as shown in FIG. 10, in order to illustrate the operation of the coupling device; and

FIG. 10 is a cross sectional view taken along lines 10-10 of FIG. 9.

### DETAILED DESCRIPTION OF THE PREFERRED EMBODIMENT

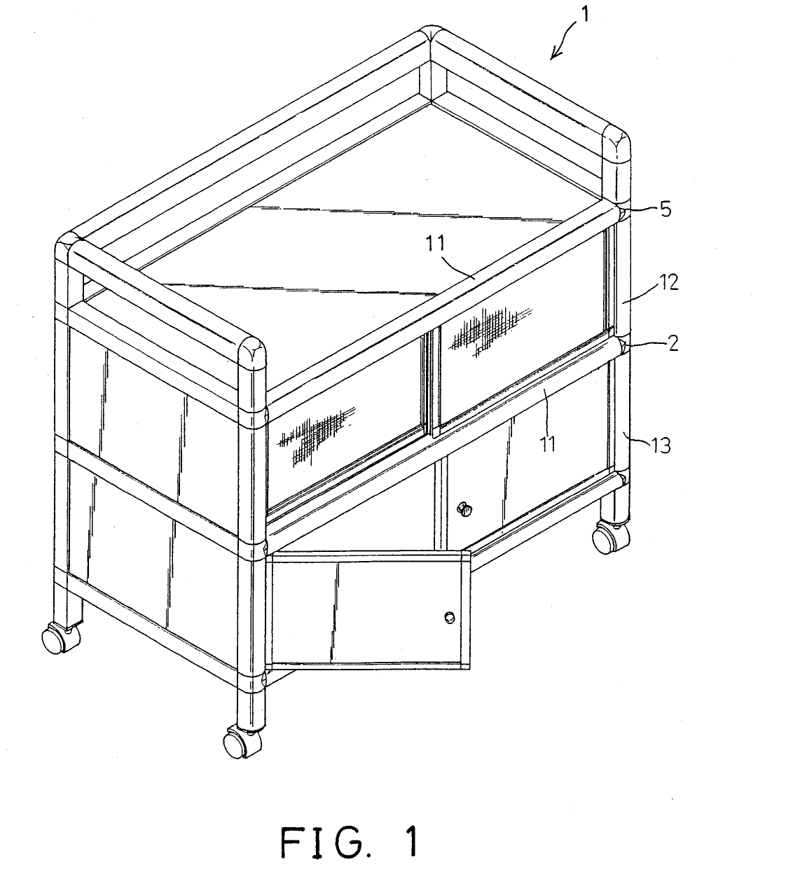

Referring to the drawings, and initially to FIGS. 1-3, a coupling device in accordance with the present invention comprises one or more corner members or coupler members 2, 5, and a number of bars or beams 11, 12, 13 to be coupled and secured together with the coupler members 2, 5.

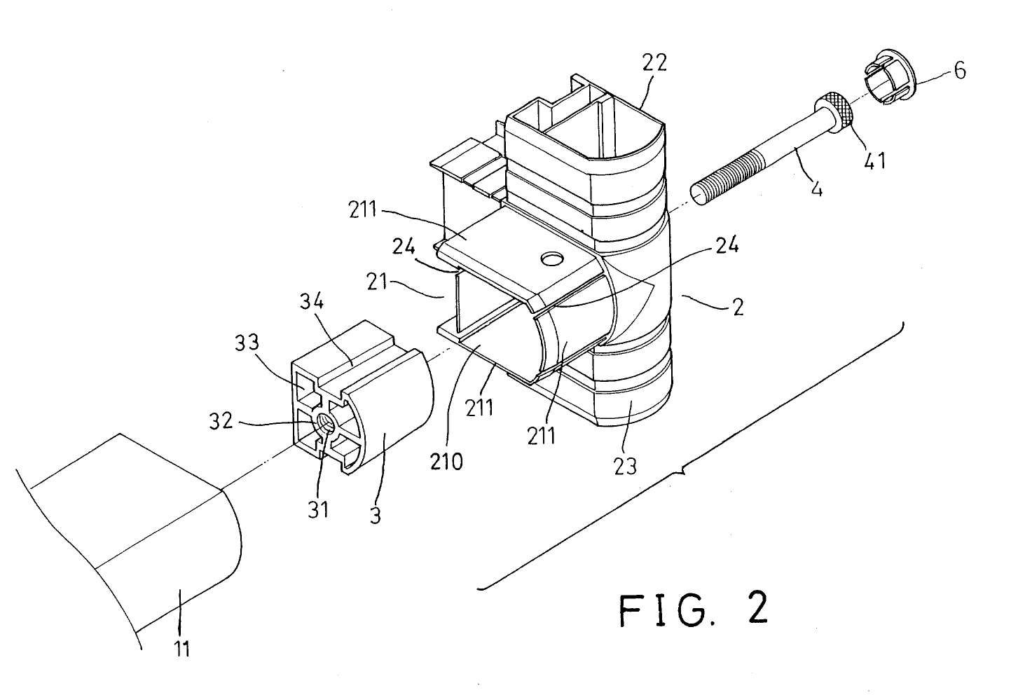

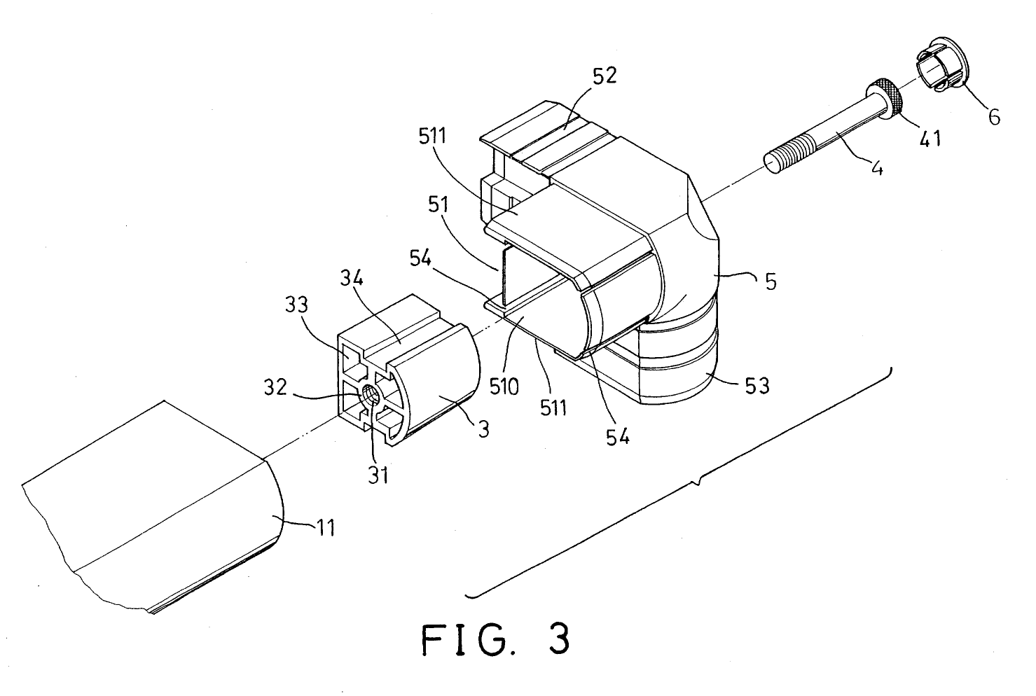

As best shown in FIGS. 2 and 3, the coupler members 2, 5 each includes two or more strut members 21, 22, 23, 51, 52, 53 extended therefrom for engaging into the ends of the beams 11, 12, 13, and to be secured to the beams 11-13 with catches 3, and fasteners 4, or the like.

For example, either of the strut members 21, 51 may be engaged into the end of the beam 11, and may include a chamber 210, 510 formed therein to receive the respective catch 3, and may include one or more spring blades 211, 511 formed thereon and defined by one or more slots 24, 54 therein.

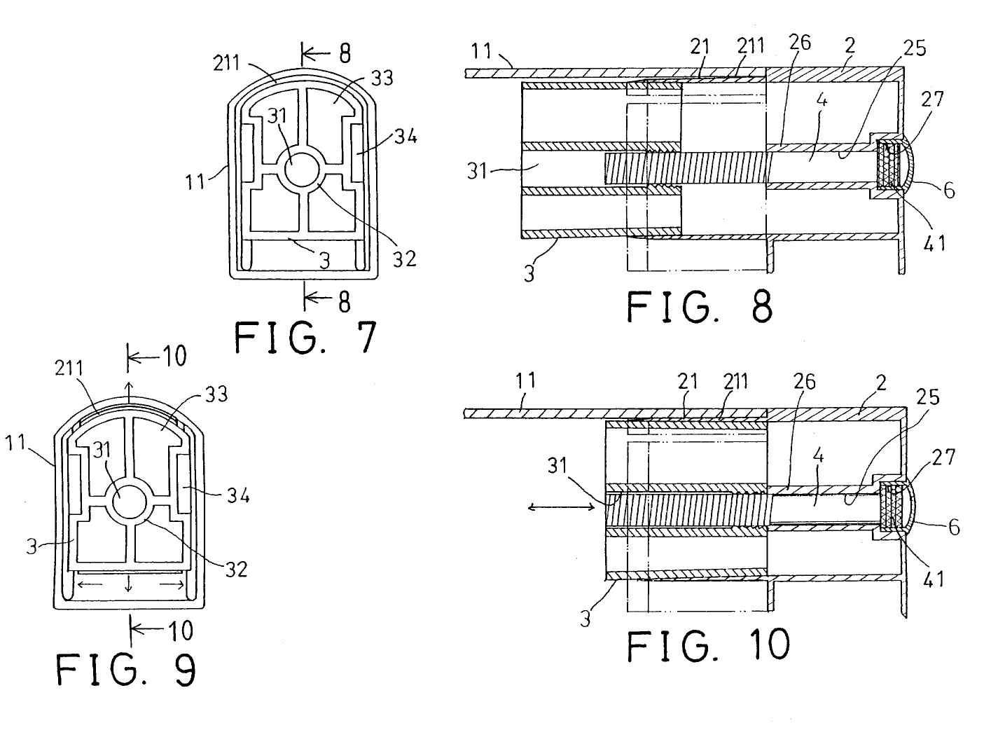

As best shown in FIGS. 7-10, the spring blades 211, 511 of the strut members 21, 51 may thus be received or engaged between the beams 11 and the catches 3 respectively, and are arranged to be forced outwardly to solidly engage with the beams 11 by the catches 3 respectively.

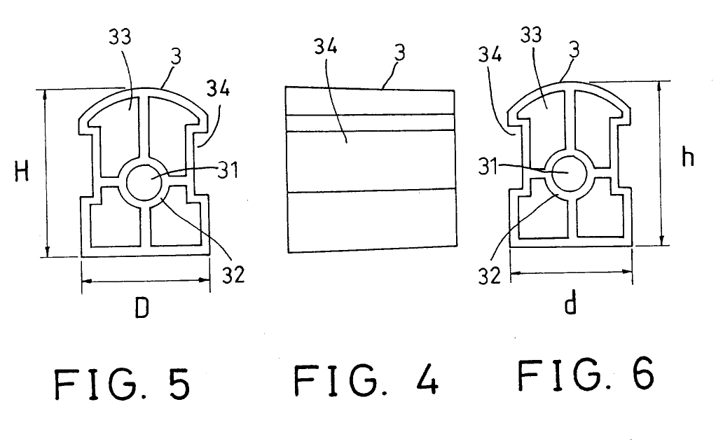

As shown in FIGS. 4-6, the catch 3 includes a screw hole 31 formed therein, and defined by such as a hub 32, and includes one or more openings 33 and/or notches 34 formed therein, for weight reducing purposes. The catch 3 is to be received in the chamber 210, 510 of the respective strut member 21, 51, and to be engaged with the spring blades 211, 511 of the respective strut member 21, 51.

The catch 3 includes one side, such as the left side having a greater height “H” and/or a greater width or depth “D” then the respective height “h” and/or the width or depth “d” of the other side, such as the right side, and preferably includes an inclination or slope or width or depth gradually decreased from the left side toward the right side thereof, such that the catch 3 may include a wedge-like configuration.

The catch 3 may thus include an inclined or tapered outer configuration or wedge-shaped configuration inclined from one (left) side toward the other (right) side thereof. The narrower right side of the catch 3 is arranged to be easily engaged into the chamber 210, 510 of the respective strut member 21, 51.

As shown in FIGS. 8 and 10, the coupler member 2, 5 may include an orifice 25 formed therein and defined by a tubular member 26, for receiving the fastener 4, and a cavity 27 formed in the outer portion thereof and communicating with the orifice 25 thereof, to receive a head 41 of the fastener 4. A cap 6 may be engaged onto the coupler member 2, 5 in order to enclose or shield the head 41 of the fastener 4.

In operation, as shown in FIGS. 7 and 8, while assembling the beam 11 to the coupler members 2, 5, the catch 3 is first engaged into the chamber 210, 510 of the respective strut member 21, 51 of the coupler members 2, 5, and the fastener 4 is engaged through the orifice 25 of the coupler members 2, 5, and threaded with the screw hole 31 of the catch 3. The strut member 21, 51 is then engaged into the end of the beam 11.

As shown in FIGS. 9 and 10, when the fastener 4 is rotated relative to the coupler members 2, 5, the fastener 4 may be forced to thread with the screw hole 31 of the catch 3, in order to force or move the catch 3 into or out of the chamber 210, 510 of the respective strut member 21, 51 of the coupler members 2, 5.

When the catch 3 is forced or moved into the chamber 210, 510 of the respective strut member 21, 51 of the coupler members 2, 5, the catch 3 may gradually force the spring blades 211, 511 of the respective strut member 21, 51 outwardly to engage with the beam 11, in order to solidly secure the strut member 21, 51 to the beam 11.

On the contrary, when the catch 3 is moved out of the chamber 210, 510 of the respective strut member 21, 51, the catch 3 may gradually release the spring blades 211, 511 of the respective strut member 21, 51 from the beam 11, for allowing the strut member 21, 51 to be disengaged from the beam 11.

Accordingly, the coupling device in accordance with the present invention may be used for easily and solidly coupling beams or bars and coupler members of furniture facilities together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A coupling device comprising:
a beam,
at least one coupler member including a strut member engaged into said beam, and having a chamber formed therein,
a catch received in said chamber of said at least one coupler member, and including a first side and a second side, and including an inclined outer configuration inclined from said first side toward said second side thereof, and said first side of said catch being provided for easily engaging into said chamber of said at least one coupler member, and
means for moving said catch relative to said strut member, to selectively force said strut member to engage with said beam, and to lock said strut member to said beam.

2. The coupling device as claimed in claim 1, wherein said strut member of said at least one coupler member includes at least one slot formed therein, to form at least one spring blade in said strut member, and to allow said at least one spring blade of said strut member to be easily forced against said beam.

3. The coupling device as claimed in claim 1, wherein said at least one coupler member includes an orifice formed therein, said catch includes a screw hole formed therein, said moving means includes a fastener engaged through said orifice of said at least one coupler member, and threaded with said screw hole of said catch, in order to move said catch relative to said strut member when said fastener is rotated relative to said at least one coupler member and said catch.

4. The coupling device as claimed in claim 3, wherein said at least one coupler member includes a cavity formed therein and communicating with said orifice thereof, said fastener includes a head engaged in said cavity of said at least one coupler member.

5. The coupling device as claimed in claim 4 further comprising a cap engaged onto said at least one coupler member, in order to block said cavity of said at least one coupler member, and to shield said head of said fastener.
